(19) United States
(12) Patent Application Publication
(10) Pub. No.: US 2025/0283359 A1
(43) Pub. Date: Sep. 11, 2025

(54) LOCK DEVICE FOR OPENING/CLOSING BODY

(71) Applicant: PIOLAX, INC., Kanagawa (JP)

(72) Inventor: Hisashi NAKASONE, Kanagawa (JP)

(73) Assignee: PIOLAX, INC., Kanagawa (JP)

(21) Appl. No.: 18/858,538

(22) PCT Filed: Apr. 17, 2023
(86) PCT No.: PCT/JP2023/015358

§ 371 Date: Oct. 21, 2024

(30) Foreign Application Priority Data
Apr. 22, 2022 (JP) 2022-070766

(51) Int. Cl. E05B 83/30; E05B 85/06

(52) U.S. Cl. CPC E05B 83/30; E05B 85/06

(57) ABSTRACT

A lock device for an opening-closing body includes: a base member; and an operating member. The operating member has an operating plate portion, an operating portion, an operating load transmission wall portion protruding, the shaft portions disposed so as to protrude from both sides of the operating load transmission wall portion or the shaft support portions, and a stopper portion connected to the operating load transmission wall portion on a side of the operating portion with respect to the shaft portions or the shaft support portions. The base member has a pair of deformation restriction wall portions disposed outside portions of the operating load transmission wall portion where the shaft portions or the shaft support portions are provided, the shaft support portions or the shaft portions, and a stopper receiving portion that is configured to restrict rotation of the operating member.

### TECHNICAL FIELD

The present invention relates to a lock device for an opening-closing body for locking the opening-closing body, which is openably and closably attached to an opening portion of a fixed body, in a closed state.

### BACKGROUND ART

For example, an opening-closing body such as a lid is attached to an opening portion formed in a fixed body such as an automobile glove box so as to be openable and closable. A lock device is provided between the opening portion and the opening-closing body, which locks the opening-closing body when it is closed and can unlock the opening-closing body when it is opened.

For example, Patent Literature 1 listed below describes a lock device having a base member fixed to an outer member, an operating member rotatably supported by the base member, and a rod that can be engaged with and disengaged from a locked portion of a fixed member in conjunction with rotation of the operating member, in which the operating member has an operating portion exposed on a front side of the outer member and a shaft support portion supported on the base member, and the base member has a hook portion that is hooked onto an attachment edge portion formed on the outer member, and a lock claw portion that is engaged with a lock edge portion formed on a back side of the outer member and that restricts movement of the base member in a direction away from a back surface of the outer member.

The base member has a pair of wall portions arranged opposite each other, an arc-protrusion-shaped shaft support portion protruding from each wall portion, and a stopper portion provided between the pair of wall portions. The operating member has a long plate-shaped base portion, an operating portion provided at one end of the base portion in a longitudinal direction, a pair of side wall portions erected from longitudinal side edges of the base portion, an arc-groove-shaped shaft portion provided on each side wall portion, a cylindrical portion erected from a back side of the base portion, in which a hole for a key cylinder is formed and into which the key cylinder is inserted, and a rotation stopper portion provided at a tip end of the cylindrical portion in an erection direction.

The pair of side wall portions of the operating member are placed outside the pair of wall portions of the base member, and the pair of shaft support portions are inserted into the pair of shaft portions, so that the operating member is rotatably attached to the base member.

When the operating member is rotated to the maximum extent with respect to the base member, the rotation stopper portion of the operating member comes into contact with the stopper portion of the base member, restricting further rotation.

### CITATION LIST

### Patent Literature

Patent Literature 1: WO2017/086427A1

### SUMMARY OF INVENTION

### Technical Problem

In the case of the lock device of Patent Literature 1, when the operating member is rotated to the maximum extent with respect to the base member, an operating force (operating load) of the operating member is transmitted from the rotation stopper portion through the cylindrical portion in which the hole for the key cylinder is formed and the base portion to the pair of side wall portions and acts on the pair of shaft portions. In this case, in order to increase breaking strength of the operating member, it is necessary to increase rigidity of the rotation stopper portion, cylindrical portion, base portion, and pair of side wall portions, but this leads to an increase in mass, making it difficult to increase the breaking strength of the operating member, which is inconvenient.

Therefore, an object of the present invention is to provide a lock device for an opening-closing body that can increase breaking strength of an operating member when the operating member is rotated to the maximum extent with respect to a base member without increasing rigidity of the operating member.

### Solution to Problem

In order to achieve the above object, the present invention provides a lock device for an opening-closing body that is configured to be openably and closably attached to an opening portion of a fixed body, the lock device including a lock portion provided on one of the fixed body or the opening-closing body, a lock member that is disposed on another of the fixed body or the opening-closing body and that is configured to engage with and disengage from the lock portion, a base member that is fixed to the other of the fixed body or the opening-closing body, and an operating member that is rotatably supported on the base member via a rotation portion and that is configured to operate the lock member, in which the rotation portion is formed by shaft portions provided on one of the operating member or the base member, and shaft support portions provided on another of the operating member or the base member to rotatably support the shaft portions, the operating member has an operating plate portion extending in a plate shape, an operating portion provided at one end of the operating plate portion in an extension direction, an operating load transmission wall portion protruding from a back side of the operating plate portion, the shaft portions disposed so as to protrude from both sides of the operating load transmission wall portion toward the outside of the operating member or the shaft support portions disposed on the operating load transmission wall portion, and a stopper portion connected to the operating load transmission wall portion on a side of the operating portion with respect to the shaft portions or the shaft support portions, and the base member has a pair of deformation restriction wall portions disposed outside portions of the operating load transmission wall portion where the shaft portions or the shaft support portions are provided, the shaft support portions disposed on the pair of deformation restriction wall portions or the shaft portions disposed to protrude from the pair of deformation restriction wall portions toward the operating load transmission wall portion, and a stopper receiving portion that is capable of coming into contact with the stopper portion and that is configured to restrict rotation of the operating member.

### ADVANTAGEOUS EFFECTS OF INVENTION

According to the present invention, when the operating portion is operated to rotate the operating member to the maximum extent with respect to the base member, the stopper portion comes into contact with the stopper receiving portion, restricting the rotation of the operating member. In this case, since the stopper portion is connected to the operating load transmission wall portion on which the shaft portion or the shaft support portion is arranged, the operating load received by the stopper portion from the stopper receiving portion is transmitted to the shaft portion via the operating load transmission wall portion, and the portions of the operating load transmission wall portion on which the shaft portions or the shaft support portions are arranged, or the shaft portions arranged to protrude from both sides of the operating load transmission wall portion or the shaft support portions arranged on the operating load transmission wall portion, try to be deformed so as to expand outward from the operating member, but the deformation is restricted by the pair of deformation restriction wall portions. As a result, the breaking strength (resistance to breaking of the operating member) of the operating member can be increased without increasing the rigidity of the operating member.

### BRIEF DESCRIPTION OF DRAWINGS

FIG. 1 is an exploded perspective view illustrating a first embodiment of a lock device for an opening-closing body according to the present invention.

FIG. 2 is an enlarged exploded perspective view of a main part of the lock device.

FIG. 3 is a perspective view of an operating member forming the lock device, as viewed from a direction different from that of FIG. 2.

FIG. 4 is a rear view of the operating member forming the lock device.

FIG. 5 is an enlarged perspective view of the lock device.

FIG. 6 is a cross-sectional view taken along the arrow line E-E in FIG. 5.

FIG. 7 is a cross-sectional view taken along the arrow line G-G in FIG. 5.

FIG. 8 is a cross-sectional view taken along the arrow line H-H in FIG. 5.

FIG. 9 is a cross-sectional view when the operating member is operated with respect to a base member from a state illustrated in FIG. 6.

FIG. 10 is an explanatory diagram of a state in which the opening-closing body is closed by the lock device.

FIG. 11 is an explanatory diagram of a state in which the opening-closing body is opened by the lock device.

FIG. 12 is an explanatory diagram illustrating a modified example of an operating load transmission wall portion.

FIG. 13 is a perspective view illustrating a second embodiment of the lock device for the opening-closing body according to the present invention.

FIG. 14 is a perspective view of an operating member forming the lock device.

FIG. 15 is a perspective view of a cover member forming the lock device, as viewed from a different direction from that of FIG. 13.

FIG. 16 is a cross-sectional view taken along the arrow line I-I of FIG. 13.

FIG. 17 is a cross-sectional view taken along the arrow line J-J of FIG. 13.

FIG. 18 is an explanatory diagram of the lock device when the operating member is operated with respect to a base member.

FIG. 19 is a cross-sectional view illustrating a third embodiment of the lock device for the opening-closing body according to the present invention.

FIG. 20 is a cross-sectional view seen from a different direction from that of FIG. 19.

FIG. 21 is a rear view of an operating member forming the lock device.

FIG. 22 illustrates a fourth embodiment of the lock device for the opening-closing body according to the present invention, illustrating a perspective view of an operating member forming the lock device.

FIG. 23 is a perspective view of a cover member forming the lock device.

FIG. 24 is an explanatory diagram illustrating an assembly process of the lock device.

FIG. 25 is a cross-sectional view of the lock device.

### DESCRIPTION OF EMBODIMENTS

### First Embodiment of Lock Device for Opening-Closing Body

Hereinafter, a first embodiment of a lock device for an opening-closing body according to the present invention will be described with reference to the drawings.

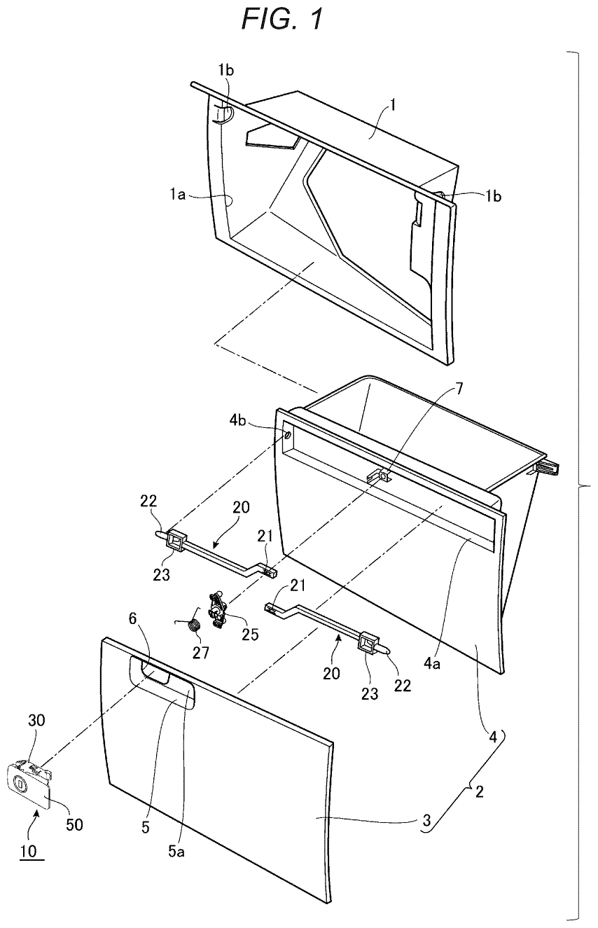

As illustrated in FIG. 1, a lock device 10 for an opening-closing body (hereinafter referred to as the “lock device 10”) in this embodiment is used for locking an opening-closing body 2, such as a glove box, which is openably and closably attached to an opening portion la of a fixed body 1, such as an instrument panel of a vehicle.

The lock device 10 of this embodiment is mainly formed by a pair of lock portions 1b, 1b provided at the opening portion la of the fixed body 1, a pair of lock members 20, 20 arranged on the opening-closing body 2 and engaging with and disengaging from the pair of lock portions 1b, 1b, a rotation member 25 rotatably supported on the opening-closing body 2 and sliding the pair of lock members 20, 20 in conjunction with each other, urging means (torsion spring 27) that urges the pair of lock members 20, 20 in a direction to engage with the pair of lock portions 1b, 1b, a base member 30 fixed to the opening-closing body 2, and an operating member 50 that is rotatably supported on the base member 30 via a rotation portion and operates the pair of lock members 20, 20. In this embodiment, hole-shaped lock portions 1b, 1b are provided on both inner surfaces of the opening portion 1a of the fixed body 1 in a width direction. In addition, the rotation portion in this embodiment is formed by a shaft portion 61 provided on the operating member 50 and a shaft support portion 37 provided on the base member 30 for supporting the shaft portion 61 rotatably.

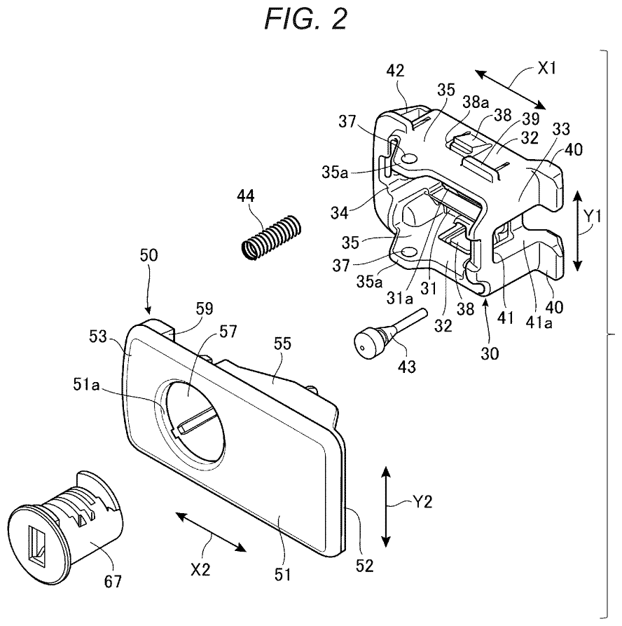

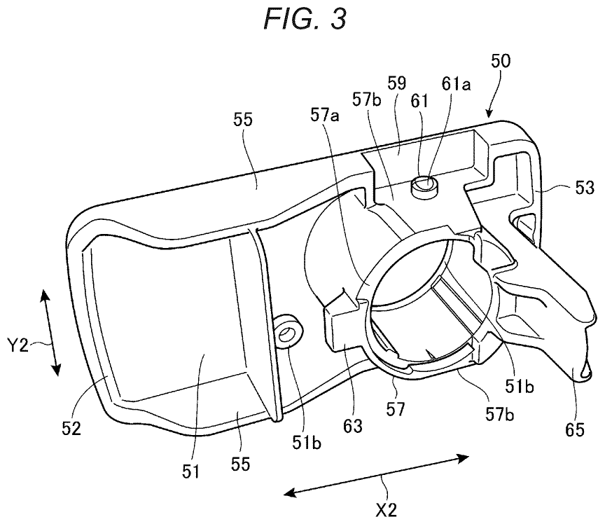

As illustrated in FIGS. 2 and 3, the operating member 50 includes an operating plate portion 51 extending in a plate shape with a predetermined length, an operating portion 52 provided at one end of the operating plate portion 51 in an extension direction, an operating load transmission wall portion 57 (hereinafter also simply referred to as a “transmission wall portion 57”) protruding from a back side of the operating plate portion 51, the above-mentioned shaft portions 61, 61 arranged to protrude from both sides of the transmission wall portion 57 toward the outside of the operating member 50, and a stopper portion 63 connected to the transmission wall portion 57 on the operating portion 52 side with respect to the shaft portion 61. In the present invention, the stopper portion 63 being connected to the transmission wall portion 57 means that the stopper portion 63 is directly connected to the transmission wall portion 57 and formed integrally therewith.

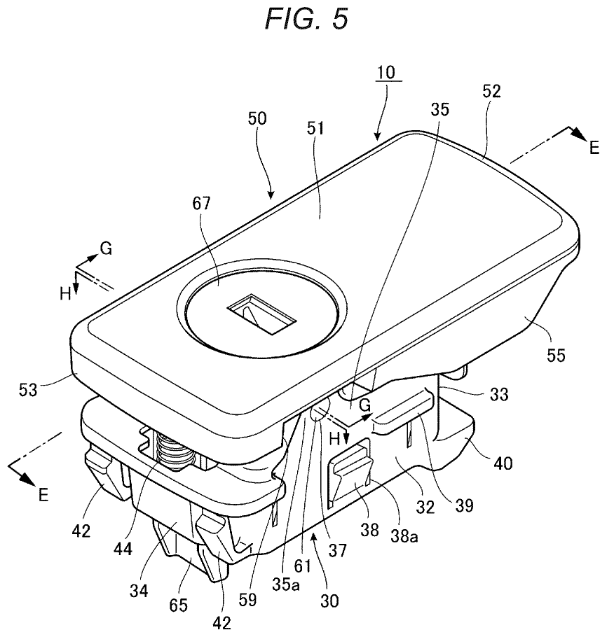

As illustrated in FIGS. 2, 5, and the like, the base member 30 includes a pair of deformation restriction wall portions 35, 35 (hereinafter also simply referred to as a “restriction wall portion 35”) arranged outside a part of the transmission wall portion 57 where the shaft portion 61 is provided, the above-mentioned shaft support portions 37, 37 formed on the pair of restriction wall portions 35, 35 and rotatably supporting the shaft portions 61, 61, and a stopper receiving portion 41 that is capable of coming into contact with the stopper portion 63 and thereby restricts rotation of the operating member 50.

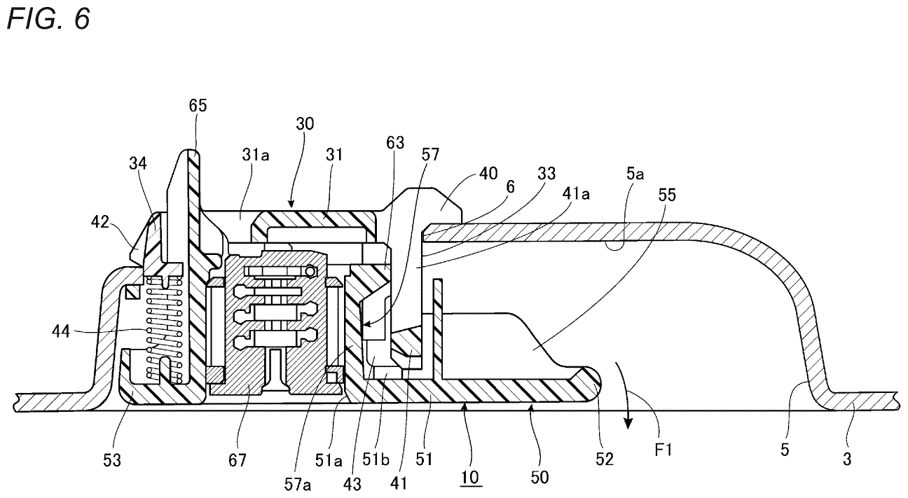

As illustrated in FIG. 1, in this embodiment, hole-shaped lock portions 1b, 1b are provided on both inner surfaces of the opening portion 1a of the fixed body 1 in the width direction. Also as illustrated in FIG. 1, the opening-closing body 2 in this embodiment is formed by an outer member 3 arranged on an inner side of an vehicle interior and an inner member 4 arranged on a back side of the outer member 3. An accommodation recess portion 5 having a horizontally elongated rectangular concave shape is formed on an upper side of one side in the width direction of the outer member 3. The base member 30 and the operating member 50 are accommodated in this accommodation recess portion 5 (see FIG. 6). Furthermore, a mounting hole 6 having a long hole shape is formed in a bottom portion 5a of the accommodation recess portion 5.

The base member 30 is attached from a front side of the mounting hole 6. The “front side” or “front surface side” here refers to the side or surface located in a direction in which the opening-closing body opens from the opening portion of the fixed body such as a vehicle. When the fixed body is provided on a vehicle, the “front side” or “front surface side” may refer to a vehicle inner space side. The “back side” or “back surface side” refers to the side opposite the “front side” or “front surface side”, that is, the side or surface located in a direction in which the opening-closing body closes. The terms “front side”, “front surface side”, “back side”, and “back surface side” have the same meanings not only for the mounting hole, but also for other members (such as the base member 30 and the operating member 50) described below.

As illustrated in FIG. 1, the inner member 4 is generally box-shaped with an open top. An upper portion of the front surface side (front side) of the inner member 4 that faces the outer member 3 is provided with a lock arrangement recess portion 4a having a horizontally elongated concave shape in which the pair of lock members 20, 20 are slidably arranged. Lock insertion holes 4b, 4b are formed on both sides of the lock arrangement recess portion 4a in a longitudinal direction. A rotation member support portion 7 for supporting the rotation member 25 in a rotatable manner protrudes from the front surface side of the bottom surface of the lock arrangement recess portion 4a.

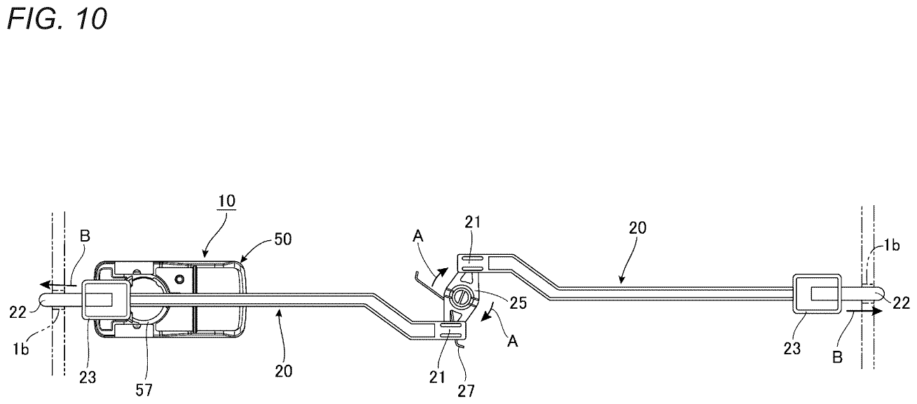

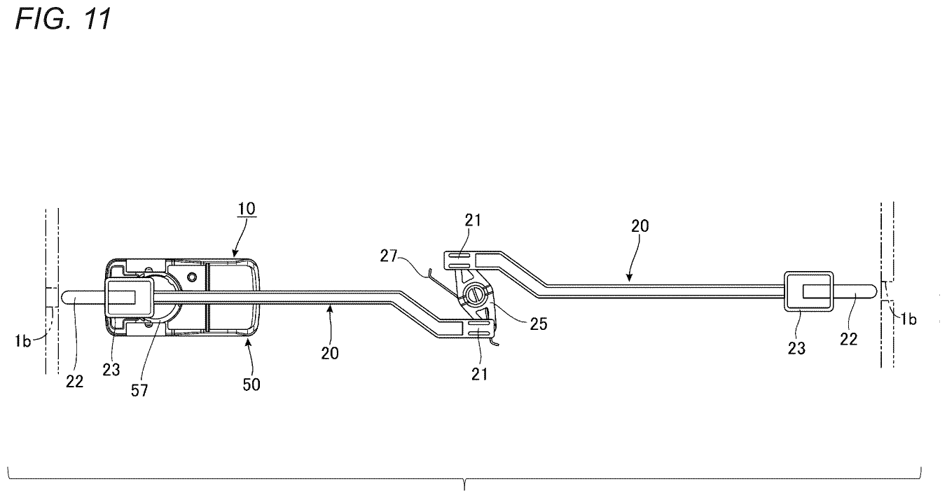

As illustrated in FIGS. 1 and 10, the pair of lock members 20, 20 in this embodiment have the same shape, with a base end 21 bent in a crank shape and extending linearly toward a tip end side, and a tip end 22 engages with and disengages from the lock portion 1b (see FIGS. 10 and 11). A frame portion 23 having a quadrangular frame shape is provided on the tip end 22 side of each lock member 20.

The rotation member 25 has a substantially diamond shape with a long axis (see FIG. 10), and its longitudinal intermediate portion is rotatably supported by the rotation member support portion 7, and both longitudinal ends are respectively connected to the base ends 21, 21 of the pair of lock members 20, 20. When the rotation member 25 rotates in a predetermined direction, the pair of lock members 20, 20 slide synchronously through the rotation member 25. The torsion spring 27 is attached to the rotation member 25, and the rotation member 25 is urged to rotate as illustrated in a direction of the arrow A in FIG. 10, whereby the tip ends 22, 22 of the pair of lock members 20, 20 are urged in a direction (a direction of the arrow B in FIG. 10) to engage with the pair of lock portions 1b, 1b. The tip ends 22, 22 of the pair of lock members 20, 20 are inserted through lock insertion holes 4b, 4b provided in the lock arrangement recess portion 4a.

Next, the base member 30 will be described in detail with reference to FIG. 2 and FIGS. 5 to 8 and the like.

The base member 30 in this embodiment is formed by a bottom wall 31 having a long plate shape that is long in one direction, a pair of side wall portions 32, 32 that are erected from both side edges along the long sides of the bottom wall 31 and extend along an extension direction of the bottom wall 31, a connecting wall 33 that is arranged at one end side of the bottom wall 31 in the longitudinal direction and that connects the pair of side wall portions 32, 32, and a connecting wall 34 that is arranged at another end side of the bottom wall 31 in the longitudinal direction and that connects the pair of side wall portions 32, 32, and has a substantially long box shape that is open on a ceiling (upper) side opposite the bottom wall 31.

In the following description, the direction in which the bottom wall 31 extends is referred to as an “extension direction X1”, and the direction orthogonal to this extension direction X1 is referred to as a “width direction Y1” (the same applies to the base member 30 itself and to each part other than the bottom wall 31 that forms the base member 30).

A slide groove 31a is formed in the bottom wall 31 to slidably receive an operating lever 65 (see FIG. 3) of the operating member 50. Also, from the upper side (an opposite side to the bottom wall 31) of the pair of side wall portions 32, 32 and a position near the connecting wall 34, protruding pieces 35a, 35a having a substantially trapezoidal mountain shape are provided.

As illustrated in FIG. 1, the portion of the pair of side wall portions 32, 32 near another end in the extension direction X2 including the protruding pieces 35a forms a pair of restriction wall portions 35, 35. The pair of restriction wall portions 35, 35 are disposed to face the outside of the portion (here, the portion of the transmission wall portion 57 where the shaft portions 61, 61 are provided on a pair of flat surfaces 57b, 57b described below) of the transmission wall portion 57 where the shaft portion 61 is provided, and serve as a portion that restricts deformation of the transmission wall portion 57. Inner surfaces (opposing surfaces) of the pair of restriction wall portions 35, 35 are formed to be parallel to each other.

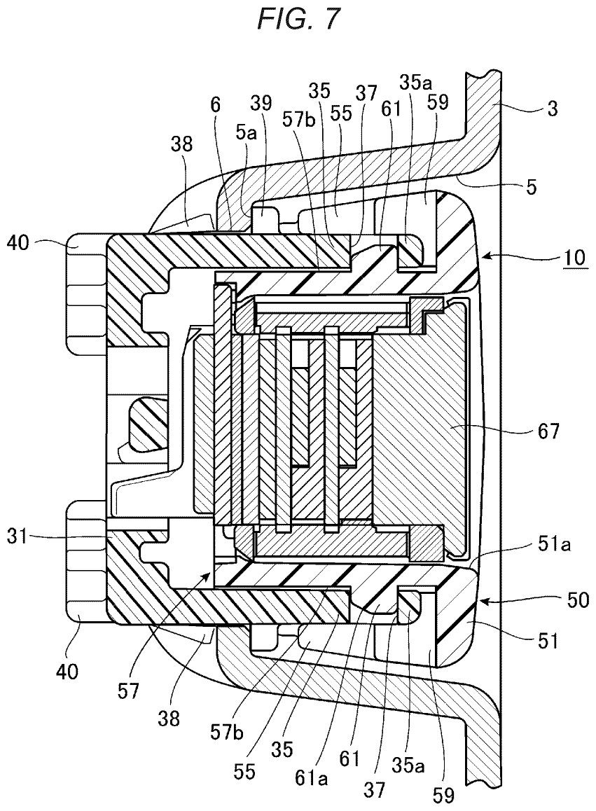

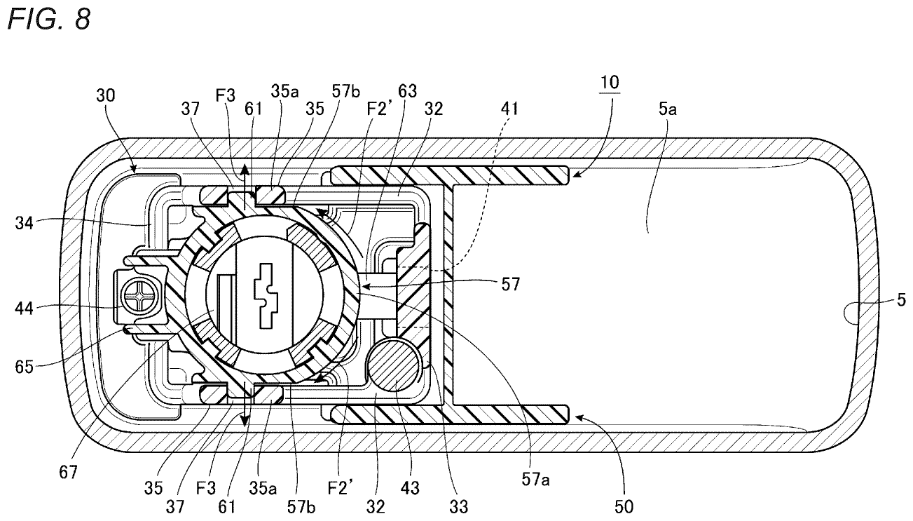

In addition, the shaft support portion 37 having a circular hole shape is formed penetrating the protruding pieces 35a, 35a forming the pair of restriction wall portions 35, 35. Then, as illustrated in FIGS. 7 and 8, each shaft portion 61 of the operating member 50 is inserted from the inside of each shaft support portion 37, and the operating member 50 is rotatably supported by the base member 30.

In addition, on an outer surface of each side wall portion 32, on the bottom wall 31 side, there is provided a flexible elastic engagement piece 38 formed through a slit 38a having a U shape, and a rib 39 protruding from a position adjacent to the elastic engagement piece 38. The elastic engagement piece 38 engages with a rear peripheral edge of the mounting hole 6, and the rib 39 engages with a front peripheral edge of the mounting hole 6 (see FIG. 7).

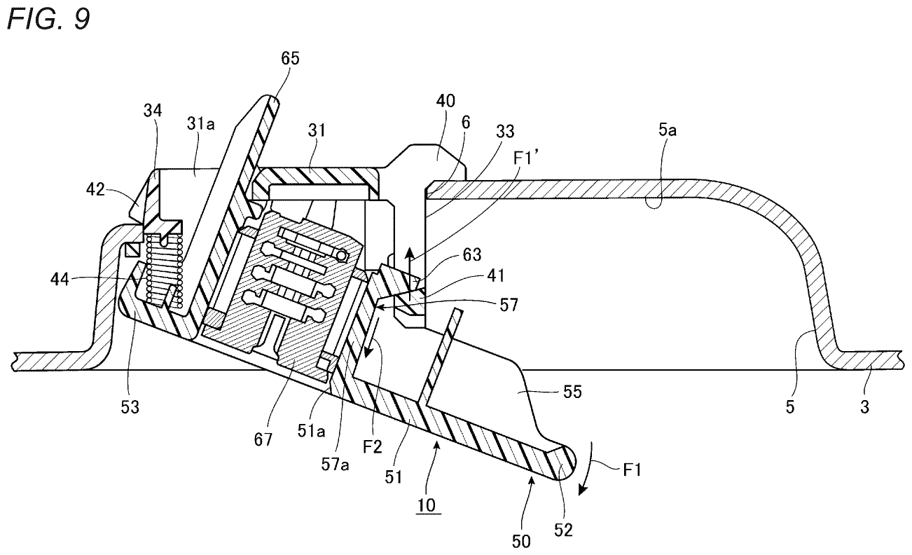

A pair of hooks 40, 40 that engage with the rear peripheral edge of the mounting hole 6 protrude from both sides of the connecting wall 33 in the width direction Y1 on the bottom wall 31 side. Furthermore, a notch 41a is formed in an intermediate portion of the connecting wall 33 in the width direction Y1 from the bottom wall 31 toward the ceiling opening, and the stopper receiving portion 41 is provided on the connecting wall 33 on an opposite side to the bottom wall 31 side through the notch 41a. As illustrated in FIG. 9, when the operating portion 52 of the operating member 50 is rotated to the maximum extent with respect to the base member 30 so as to move away from the base member 30 and the bottom portion 5a of the accommodation recess portion 5, the stopper receiving portion 41 comes into contact with the stopper portion 63, and further rotation of the operating member 50 is restricted.

A pair of elastic engagement claws 42, 42 are provided on both sides of the connecting wall 34 in the width direction Y1 on the bottom wall 31 side, which engage with the rear peripheral edge of the mounting hole 6. Furthermore, a damper 43 made of rubber is attached to a corner of one end of the base member 30 in the extension direction X1, so as to reduce hitting noise when the operating portion 52 of the operating member 50 rotates in a direction approaching the base member 30 or the bottom portion 5a of the accommodation recess portion 5. A coil spring 44 is arranged at a corner of another end of the base member 30 in the extension direction X1.

Next, the operating member 50 will be described in detail with reference to FIGS. 2 to 8 and the like.

In this embodiment, the operating member 50 is elongated in one direction overall, and includes the operating plate portion 51 having a substantially elongated plate shape that is plate-like and extends with a predetermined length. In the following description, a direction in which the operating plate portion 51 extends is referred to as an “extension direction X2”, and a direction orthogonal to the extension direction X2 is referred to as a “width direction Y2” (this applies to the operating member 50 itself, each part other than the operating plate portion 51 that forms the operating member 50, and also to a cover member 70 described below).

The operating portion 52 is provided at one end (tip end) of the operating plate portion 51 in the extension direction X2, which is a portion that an operator grasps and operates when rotating the operating member 50. Another end of the operating plate portion 51 in the extension direction X2 is a base end 53 that is rotatably supported by the pair of shaft support portions 37, 37 of the base member 30. Furthermore, a cylinder insertion hole 51a having a circular hole shape is formed at the other end side of the operating plate portion 51 in the extension direction X2, through which a key cylinder 67 is inserted. A damper abutment portion 51b having a substantially cylindrical protrusion shape that abuts against the damper 43 is provided on the back side (the side facing the base member 30) of the operating plate portion 51, near one end in the extension direction X2.

Furthermore, a pair of side walls 55, 55 extending along the extension direction X2 of the operating plate portion 51 are erected from both side edges of the operating plate portion 51 in the width direction Y2 toward the back side (toward the base member 30). Furthermore, recess portions 59, 59 are formed on another end side of the pair of side walls 55, 55 in the extension direction X2 to receive a pair of protruding pieces 35a, 35a of the base member 30.

The transmission wall portion 57 having a substantially cylindrical shape into which the key cylinder 67 can be inserted is erected on the rear side of the operating plate portion 51 from a rear peripheral edge of the cylinder insertion hole 51a. As will be described in detail below, as illustrated in FIG. 8, this transmission wall portion 57 transmits an operating load input via the stopper portion 63 to the pair of shaft portions 61, 61 (see the arrow F2′ in FIG. 8), and is capable of bending and deforming radially outward and radially inward. The operating load is mainly transmitted through a semicircular portion 57a (see FIG. 8) of the transmission wall portion 57 that is located on the operating portion 52 side with respect to the pair of shaft portions 61, 61.

In addition, the flat surfaces 57b, 57b that are parallel to each other and have a flat surface shape are formed on an outer periphery of both circumferentially opposing sides (both sides in the width direction Y2) of the transmission wall portion 57 at positions that align with the pair of recess portions 59, 59. A pair of shaft portions 61, 61 protrude coaxially from a position (a position on a base end side of the transmission wall portion 57 in an erection direction) of the pair of flat surfaces 57b, 57b on the operating plate portion 51 side.

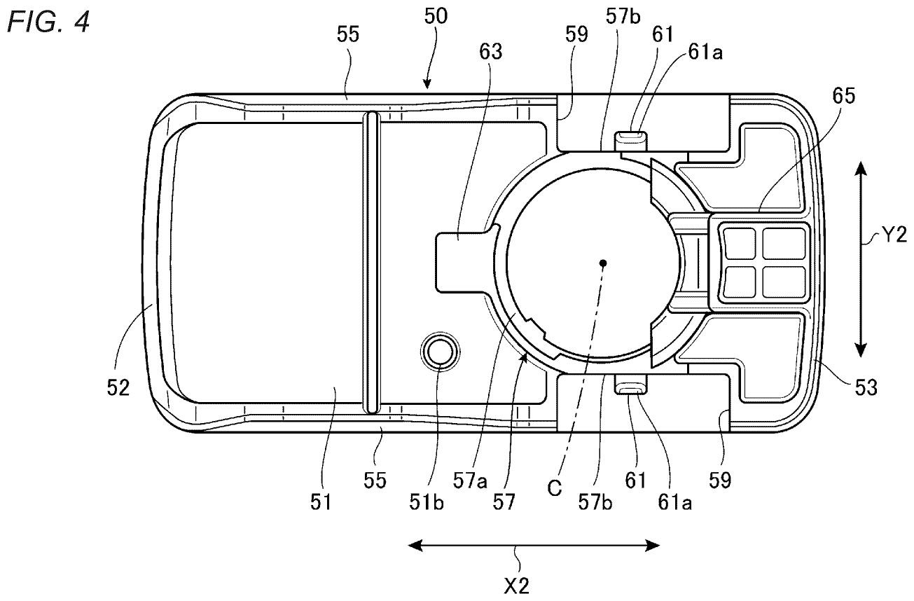

Furthermore, as illustrated in FIG. 4, when the operating member 50 is viewed from the back side (when viewed from the rear side), the pair of shaft portions 61, 61 extend from a position near the other end (near the base end 53) of the operating member 50 in the extension direction X2 with respect to an axis C of the transmission wall portion 57 along the width direction Y2 of the operating member 50, and are connected to the transmission wall portion 57. Also, as illustrated in FIG. 3, at the tip end of each shaft portion 61, a tapered surface 61a is formed that is cut obliquely from the base end side in an erection direction of the transmission wall portion 57 toward the tip end side in the erection direction, making it easy to insert the shaft portion 61 from the inside of the shaft support portion 37.

When assembling the operating member 50 to the base member 30, the pair of shaft portions 61, 61 of the operating member 50 are inserted between the pair of protruding pieces 35a, 35a of the base member 30, and the operating member 50 is pressed against the base member 30. The pair of shaft portions 61, 61 are then inserted into the pair of shaft support portions 37, 37 of the base member 30 from the inside (see FIGS. 7 and 8), so that the operating member 50 is rotatably supported against the base member 30. As a result, the pair of restriction wall portions 35, 35 of the base member 30 are arranged so as to face the outer sides of the pair of flat surfaces 57b, 57b (see FIGS. 7 and 8). In particular, the protruding pieces 35a, 35a forming the pair of restriction wall portions 35, 35 are disposed outside the portion of the pair of flat surfaces 57b, 57b where the pair of shaft portions 61, 61 are provided. Both the pair of flat surfaces 57b, 57b and inner surfaces of the pair of restriction wall portions 35, 35 including the protruding pieces 35a, 35a have flat surface shape, so that the flat surfaces 57b and the inner surface of the restriction wall portion 35 are disposed to face each other in close proximity, and a gap between the flat surface 57b and the inner surface of the restriction wall portion 35 is small. As illustrated in FIGS. 6 and 9, the operating member 50 rotates with respect to the base member 30, using the pair of shaft portions 61, 61 as rotation fulcrums, so that the operating portion 52 of the operating plate portion 51 of the operating member 50 approaches and moves away from the base member 30 and the bottom portion 5a of the accommodation recess portion 5.

As illustrated in FIG. 6, the coil spring 44 is interposed in a compressed state between the other end of the operating member 50 in the extension direction X2 and the other end of the base member 30 in the extension direction X1. Therefore, as illustrated in FIG. 9, when the operator rotates the operating member 50 with respect to the base member 30 so that the operating portion 52 of the operating plate portion 51 of the operating member 50 moves away from the base member 30 and the bottom portion 5a of the accommodation recess portion 5, and then releases his or her hand from the operating portion 52, the operating portion 52 is urged to rotate in a direction approaching the base member 30 and the bottom portion 5a of the accommodation recess portion 5.

As illustrated in FIG. 3, the stopper portion 63 protrudes from an outer surface of a tip end of the transmission wall portion 57 in the erection direction on the operating portion 52 side with respect to the pair of shaft portions 61, 61. The stopper portion 63 is disposed perpendicular to the pair of shaft portions 61, 61, and is connected to the transmission wall portion 57. That is, the transmission wall portion 57, the pair of shaft portions 61, 61, and the stopper portion 63 are integrally formed continuously. The stopper portion 63 comes into contact with the stopper receiving portion 41 when the operating member 50 is rotated to the maximum extent with respect to the base member 30 so that the operating portion 52 of the operating member 50 is in a direction away from the base member 30 and the bottom portion 5a of the accommodation recess portion 5, as illustrated in FIG. 9, thereby restricting further rotation of the operating member 50.

As illustrated in FIG. 3, the operating lever 65 is erected from the back side of one end of the operating plate portion 51 in the extension direction X2. A part of the operating lever 65 is connected to a portion of the transmission wall portion 57 in the circumferential direction opposite the portion where the stopper portion 63 is provided, and is erected higher than the tip end of the transmission wall portion 57 in the erection direction. The operating lever 65 is inserted from the back side of the slide groove 31a of the base member 30 and inserted into the frame portion 23 of one of the lock members 20. When the operating portion 52 of the operating member 50 rotates in a direction away from the base member 30 or the bottom portion 5a of the accommodation recess portion 5, the operating lever 65 presses the frame portion 23 of one of the lock members 20, thereby sliding the tip ends 22, 22 of the pair of lock members 20, 20 via the rotation member 25 in a direction not to engage with the pair of lock portions 1b, 1b of the fixed body 1 (see FIG. 11).

In this lock device 10, when the operating portion 52 is operated to rotate the operating member 50 with respect to the base member 30 and the stopper portion 63 comes into contact with the stopper receiving portion 41, the operating load from the stopper receiving portion 41 is input to the stopper portion 63, and the operating load is transmitted from the stopper portion 63 to the transmission wall portion 57, and further transmitted to the shaft portion 61 via the transmission wall portion 57.

That is, from the state illustrated in FIG. 6, when the operating portion 52 of the operating member 50 is grasped and the operating portion 52 is rotated to the maximum extent with respect to the base member 30 in a direction away from the base member 30 and the bottom portion 5a of the accommodation recess portion 5 as illustrated by the arrow F1, the stopper portion 63 comes into contact with the stopper receiving portion 41 as illustrated in FIG. 9, restricting further rotation of the operating member 50. Then, the stopper portion 63 receives an operating load F1′ from the stopper receiving portion 41. That is, the operating load F1′ is input from the stopper receiving portion 41 to the stopper portion 63, and the operating load F1′ is transmitted from the stopper portion 63 to the transmission wall portion 57.

Then, the operating load F1′ is transmitted from the portion of the transmission wall portion 57 where the stopper portion 63 is located, that is, a circumferential center of the semicircular portion 57a of the transmission wall portion 57 on the operating portion 52 side with respect to the pair of shaft portions 61, 61, to the base end side in an axial direction of the semicircular portion 57a as illustrated by the arrow F2 in FIG. 9, and is also transmitted to both ends of the semicircular portion 57a in the circumferential direction as illustrated by the arrow F2′ in FIG. 8. As a result, the operating load F1′ is applied to the portion of the transmission wall portion 57 where the shaft portions 61, 61 are provided, that is, the portion of the pair of flat surfaces 57b, 57b forming the transmission wall portion 57 where the pair of shaft portions 61, 61 are provided. As a result, as illustrated by the arrow F3 in FIG. 8, the pair of flat surfaces 57b, 57b attempt to bend and deform in a direction away from each other (it can also be said that the pair of flat surfaces 57b, 57b attempt to bend and deform radially outward of the transmission wall portion 57 so that a distance between the base ends of the pair of shaft portions 61, 61 increases, and further, it can be said that the pair of shaft portions 61, 61 bend and deform radially outward of the transmission wall portion 57).

In this case, the pair of restriction wall portions 35, 35 are arranged so as to face the pair of flat surfaces 57b, 57b on the outside of the pair of flat surfaces 57b, 57b. In particular, the pair of protruding pieces 35a, 35a forming the pair of restriction wall portions 35, 35 are arranged so as to face the pair of flat surfaces 57b, 57b on the outside of the portion of the pair of flat surfaces 57b, 57b where the pair of shaft portions 61, 61 are provided. Therefore, the radial outward deflection deformation of the transmission wall portion 57 of the portion of the pair of flat surfaces 57b, 57b where the pair of shaft portions 61, 61 are provided and the pair of shaft portions 61, 61 is restricted. In this embodiment, the key cylinder 67 is inserted and arranged inside the transmission wall portion 57 to restrict the radial inward deflection deformation of the transmission wall portion 57.

### Modified Example

The shapes, structures, layouts, and the like of the lock portion, lock member, base member, and operating member that form the lock device for the opening-closing body in the present invention, as well as the various parts (the operating plate portion, operating load transmission wall portion, shaft portion, stopper portion, and the like) that form the operating member, and the various parts (the deformation restriction wall portion, shaft support portion, stopper receiving portion, and the like) that form the base member are not limited to the above-described embodiment.

Furthermore, as described above, this embodiment is applied to, for example, a structure in which a box-shaped glove box is rotatably attached to an opening portion of an instrument panel (in this case, the instrument panel forms the “fixed body” and the glove box forms the “opening-closing body”), but it may also be applied to a structure in which a lid is attached to an opening portion of the instrument panel so that it can be opened and closed (in this case, the instrument panel forms the “fixed body” and the lid forms the “opening-closing body”), and can be widely used for various opening-closing bodies that open and close the opening portion of a fixed body.

Furthermore, in this embodiment, the mounting hole 6 is formed in the opening-closing body 2 and the lock member 20 is slidably arranged on the opening-closing body 2, but the mounting hole may be formed in the fixed body and the lock member may be slidably arranged on the fixed body side.

In addition, although the lock portion 1b in this embodiment is hole-shaped, the lock portion may not be hole-shaped, but may be concave, protrusion-shaped, frame-shaped, or the like, and the lock portion may be provided in the opening-closing body rather than in the opening portion of the fixed body.

Furthermore, the torsion spring 27, which is the urging means in this embodiment, urges the rotation member 25 to rotate, thereby urging the lock member 20 connected to the rotation member 25 in a direction to engage with the lock portion 1b (see FIG. 10). However, the urging means that urges the lock member in a direction such that the lock member engages with the lock portion may be, for example, a tension spring that pulls one of the lock members toward the lock portion.

In addition, in this embodiment, as described above, when the operating member 50 is rotated, one of the lock members 20 is slid, and another lock member 20 is slid via the rotation member 25. However, it may be configured so that the rotation member is rotated by rotating the operating member, thereby sliding the pair of lock members.

Furthermore, although the opening-closing body 2 in this embodiment is formed by the outer member 3 and the inner member 4, the opening-closing body may be formed by a single plate material.

In addition, the shaft support portion 37 formed in the base member 30 has a circular hole shape, but the shaft support portion may be, for example, an arc-shaped groove (this will be described in the embodiment described below) or an arc-shaped protrusion.

Furthermore, in this embodiment, the pair of shaft portions 61, 61 are connected to the transmission wall portion 57, but the shaft portion may be separate from the operating load transmission wall portion (this will be described in the embodiment described below). The shaft portion preferably has a shape that matches the shape of the shaft support portion. For example, when the shaft support portion is an arc-shaped groove as described in paragraph 0053, the shaft portion is preferably an arc-shaped protrusion.

In addition, in this embodiment, the key cylinder 67 is inserted and positioned inside the transmission wall portion 57 to restrict radially inward deflection deformation of the transmission wall portion 57, but a configuration in which a key cylinder is not inserted into the operating load transmission wall portion, or a configuration in which a separate member other than the key cylinder is inserted and positioned into the operating load transmission wall portion (this will be described in the embodiment described below), may also be used.

Furthermore, in this embodiment, a rotation portion that supports the operating member 50 to rotate on the base member 30 is formed by the shaft portion 61 provided on the operating member 50 and the shaft support portion 37 provided on the base member 30, but the rotation portion may also be formed by a shaft portion provided on the base member and a shaft support portion provided on the operating member

In this case, the shaft support portion is disposed in the operating load transmission wall portion forming the operating member, and the stopper portion forming the operating member is connected to the operating load transmission wall portion on the operating portion side with respect to the shaft support portion. The shaft portions are disposed so as to protrude from the pair of deformation restriction wall portions forming the base member toward the operating load transmission wall portion. In other words, the shaft portions are disposed to protrude from the pair of deformation restriction wall portions toward the inside of the base member so that the shaft portions protrude toward the operating load transmission wall portion that is disposed inside the pair of deformation restriction wall portions.

Further, although the transmission wall portion 57 in this embodiment is substantially cylindrical, the operating load transmission wall portion may be, for example, semi-cylindrical, triangular tubular, V-frame-shaped, U-frame-shaped, or the like.

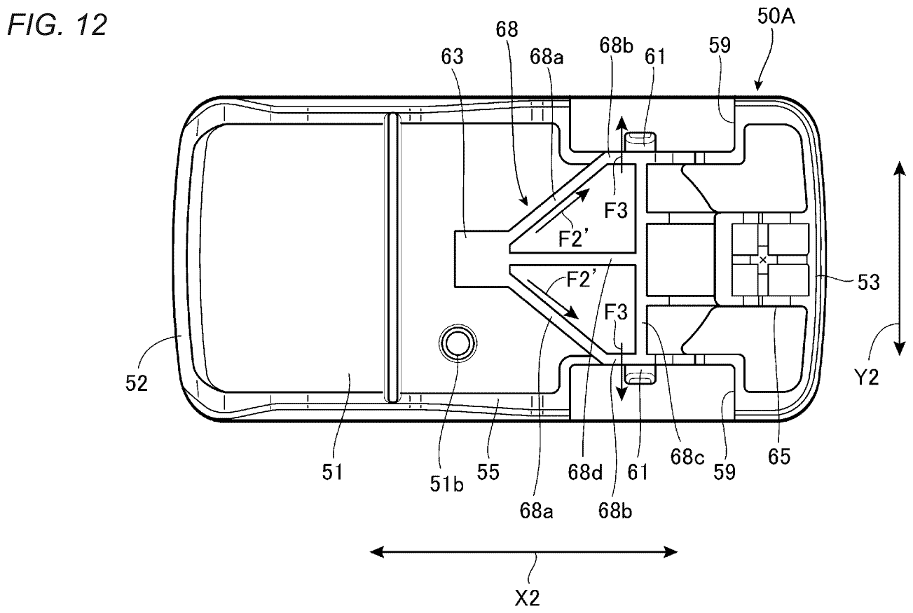

FIG. 12 illustrates a modified example of an operating load transmission wall portion 68 (hereinafter also simply referred to as a “transmission wall portion 68”). This transmission wall portion 68 is frame-shaped and includes a pair of inclined ribs 68a, 68a extending from one end side to another end side of an operating member 50A in the extension direction X2 so as to expand obliquely outward, bent ribs 68b, 68b formed at tip ends of the pair of inclined ribs 68a, 68a in the extension direction and extending along the extension direction X2 of the operating member 50A, a first connecting rib 68c connecting the bent ribs 68b, 68b and extending along the width direction Y2 of the operating member 50A, and a second connecting rib 68d extending from a base end of the pair of inclined ribs 68a, 68a in the extension direction along the extension direction X2 of the operating member 50A and connected to the center of the first connecting rib 68c in the extension direction. Further, a stopper portion 63 is provided at the base ends of the pair of inclined ribs 68a, 68a and the second connecting rib 68d in the extension direction, and shaft portions 61, 61 protrudes from outer surfaces of the bent ribs 68b, 68b.

In the case of such a transmission wall portion 68, when the operating load input from the stopper receiving portion 41 to the stopper portion 63 is transmitted from the stopper portion 63 to the transmission wall portion 57, the operating load is transmitted through the pair of inclined ribs 68a, 68a (see the arrow F2′ in FIG. 12) and acts on the pair of bent ribs 68b, 68b, so that the pair of bent ribs 68b, 68b are bent and deformed so as to expand in a direction away from each other (see the arrow F3 in FIG. 12). However, even in this case, a pair of deformation restriction wall portions (not illustrated) are arranged on the outside of the pair of bent ribs 68b, 68b to restrict the deflection deformation of the pair of bent ribs 68b, 68b in a radial outward direction.

### Operational Effects

Next, operational effects of the lock device 10 having the above configuration will be described.

In this lock device 10, the opening-closing body 2 is closed from an state where the opening-closing body 2 is opened from the opening portion 1a of the fixed body 1, and the tip ends 22, 22 of the pair of lock members 20, 20 engage with the lock portions 1b, 1b of the fixed body 1 (see FIG. 10), thereby locking the opening-closing body 2 in a closed state.

From this state, when the operating portion 52 of the operating member 50 is rotated in a direction away from the base member 30 and the bottom portion Sa of the accommodation recess portion 5, as illustrated in FIG. 9, the tip end 22 of one lock member 20 is retracted in a direction not to engage from the lock portion 1b against a rotational urging force of the rotation member 25, as illustrated in FIG. 11. In conjunction with this, the tip end 22 of the other lock member 20 is retracted in a direction not to engage from the lock portion 1b via the rotation member 25, so that a locked state of the opening-closing body 2 is released and the opening-closing body 2 can be opened from the opening portion 1a of the fixed body 1.

In this lock device 10, as described in paragraph 0043 above, when the operating portion 52 of the operating member 50 is grasped and the operating portion 52 is rotated to the maximum extent with respect to the base member 30, the stopper portion 63 comes into contact with the stopper receiving portion 41, and the operating load F1′ is input from the stopper receiving portion 41 to the stopper portion 63, and this operating load F1′ is transmitted from the stopper portion 63 to the transmission wall portion 57 (see FIG. 9). Then, as described in paragraph 0044 above, the operating load F1′ is applied to the pair of flat surfaces 57b, 57b through the semicircular portion 57a of the transmission wall portion 57 (see the arrow F2′ in FIG. 8), and as illustrated by the arrow F3 in FIG. 8, the portions of the pair of flat surfaces 57b, 57b where the pair of shaft portions 61, 61 are provided and the pair of shaft portions 61, 61 attempt to bend and deform so as to expand in a direction away from each other. In this case, the pair of restriction wall portions 35, 35 are arranged to face the pair of flat surfaces 57b, 57b on the outside of the pair of flat surfaces 57b, 57b (here, the pair of protruding pieces 35a, 35a are arranged to face them), so that the portions of the pair of flat surfaces 57b, 57b where the pair of shaft portions 61, 61 are provided, and the pair of shaft portions 61, 61 can be restricted from being bent and deformed radially outward of the transmission wall portion 57. As a result, the breaking strength (resistance to breaking of the operating member 50) of the operating member 50 can be increased without increasing the rigidity of the operating member 50.

In this embodiment, the transmission wall portion 57 is cylindrical shape so that the key cylinder 67 can be inserted therein.

According to this embodiment, before the key cylinder 67 is inserted into the transmission wall portion 57, the transmission wall portion 57 can be easily deformed radially inward. Therefore, when the transmission wall portion 57 is disposed between the pair of restriction wall portions 35, 35 of the base member 30 in order to assemble the operating member 50 to the base member 30, the transmission wall portion 57 is disposed so that the shaft portion 61 can be easily supported by the shaft support portion 37, thereby improving the workability of assembling the operating member 50 to the base member 30. In addition, when the key cylinder 67 is inserted into the transmission wall portion 57 in a state in which the shaft portion 61 is supported by the shaft support portion 37, the radially inward deformation of the transmission wall portion 57 can be restricted, so that the rigidity of the transmission wall portion 57 itself and the shaft portion 61 and stopper portion 63 provided on the transmission wall portion 57 can be increased.

### Second Embodiment of Lock Device for Opening-Closing Body

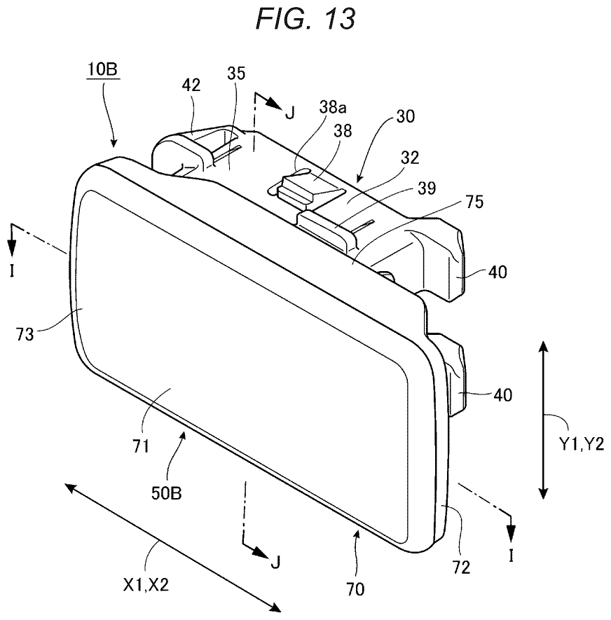

FIGS. 13 to 18 illustrate a second embodiment of the lock device for the opening-closing body according to the present invention. Parts that are substantially the same as those in the previous embodiment are given the same reference signs, and their descriptions are omitted.

A lock device 10B for the opening-closing body (hereinafter simply referred to as a “lock device 10B”) of this embodiment has a pair of notches 59B, 59B formed on both sides of an operating plate portion 51 along the extension direction X2, into which a pair of restriction wall portions 35, 35 fit, an operating member 50B further has a cover member 70 arranged on the front side of the operating plate portion 51, and the cover member 70 is provided with wall portions 75, 75 that cover the pair of notches 59B, 59B.

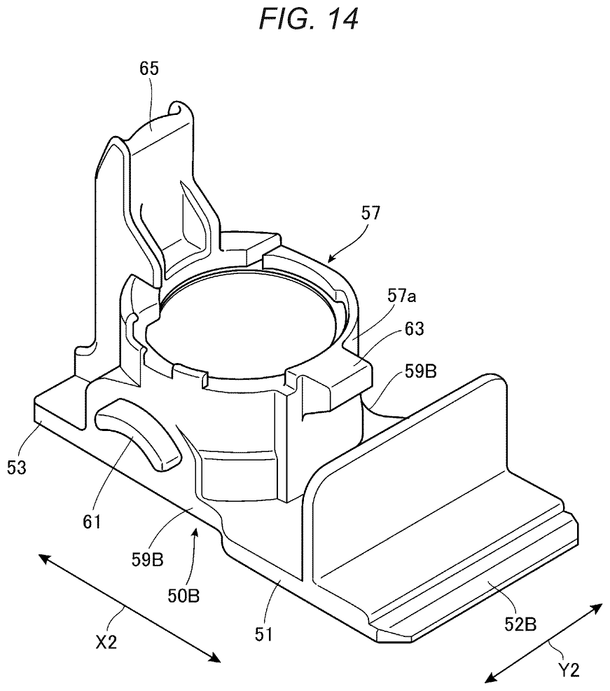

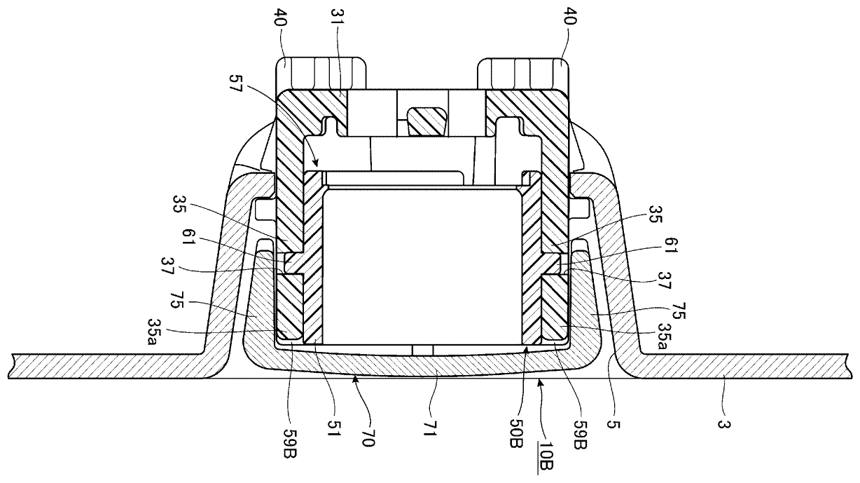

As illustrated in FIG. 14, the operating member 50B is formed with the pair of notches 59B, 59B extending along the extension direction X2 of the operating plate portion 51 on both side edges in the width direction Y2 on the base end 53 side of the operating plate portion 51. The pair of notches 59B, 59B are arranged so that a pair of protruding pieces 35a, 35a of the base member 30 can fit into them (see FIG. 17). A pair of shaft portions 61, 61 protruding from a pair of flat surfaces 57b, 57b of a transmission wall portion 57 are arc-shaped protrusions. A pair of shaft support portions 37, 37 provided on the base member 30 side are arc-shaped grooves.

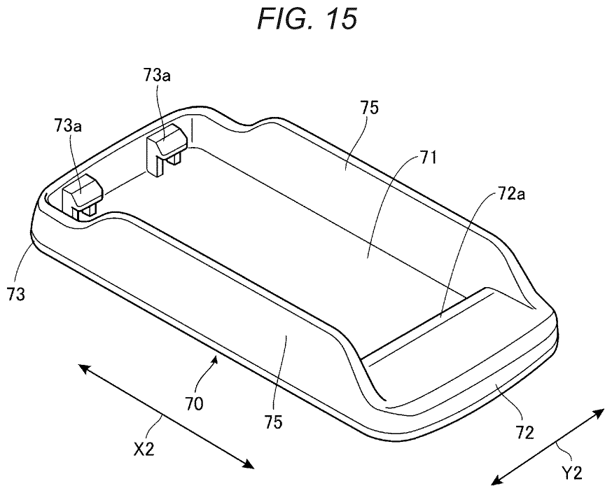

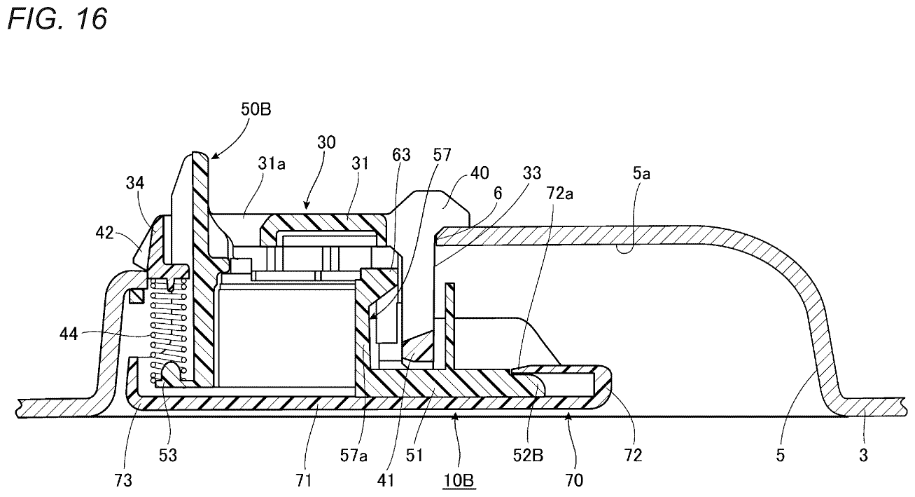

As illustrated in FIG. 15, the cover member 70 has a cover plate portion 71 having substantially elongated plate shape that is plate-like and extends in a predetermined length so as to fit the operating plate portion 51. A pair of wall portions 75, 75 extending along the extension direction X2 of the cover plate portion 71 are erected from both side edges of the cover plate portion 71 in the width direction toward the back side (toward the operating member 50B side). In addition, a pair of lock protrusions 73a, 73a are formed on the base end 73 side of the cover plate portion 71 in the extension direction X2, which lock onto both sides of the base end 53 of the operating plate portion 51 in the width direction. A tip end side of the cover plate portion 71 in the extension direction X2 forms an operating portion 72. Furthermore, a lock frame portion 72a into which a tip end 52B of the operating plate portion 51 fits and locks (see FIG. 16) is provided in the cover plate portion 71 on the base end 73 side with respect to the operating portion 72.

Then, the tip end 52B of the operating plate portion 51 is inserted into and engaged with the lock frame portion 72a of the cover plate portion 71, and the lock protrusions 73a, 73a of the cover plate portion 71 are respectively engaged with both sides of the base end 53 of the operating plate portion 51 in the width direction, thereby attaching the cover member 70 to the front side of the operating plate portion 51. As a result, as illustrated in FIG. 13, the pair of notches 59B, 59B formed in the operating plate portion 51 are respectively covered with the pair of wall portions 75, 75 of the cover member 70. As illustrated in FIG. 17, the pair of protruding pieces 35a, 35a of the base member 30 are respectively fitted to the pair of notches 59B, 59B of the operating member 50B, and further, the pair of wall portions 75, 75 of the cover member 70 are disposed outside the pair of protruding pieces 35a, 35a.

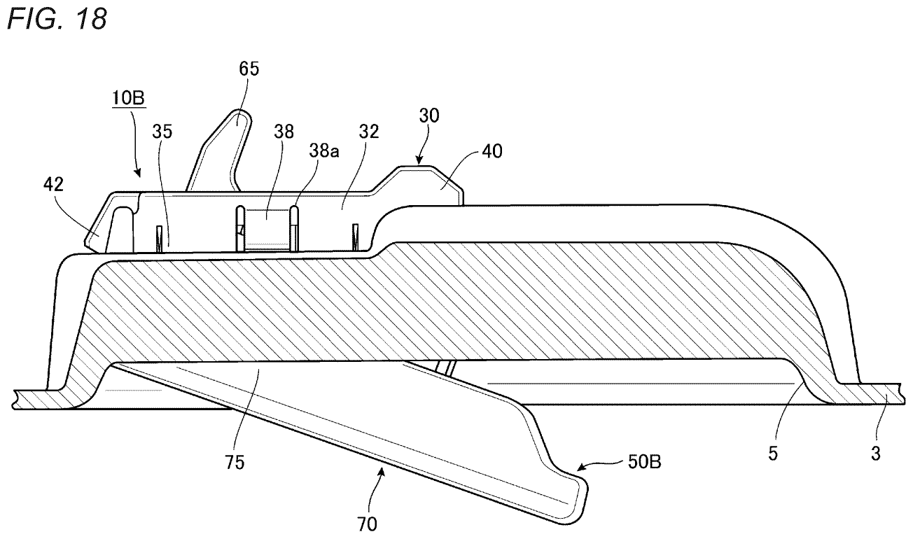

According to this embodiment, the operating member 50B further includes the cover member 70 that is disposed on the front side of the operating plate portion 51, and therefore the design of the operating member 50B can be changed as appropriate by changing the cover member 70. In addition, the cover member 70 is provided with the wall portions 75, 75 that cover the pair of notches 59B, 59B formed in the operating plate portion 51, and therefore, as illustrated in FIG. 18, when the operating member 50B is rotated with respect to the base member 30, the pair of notches 59B, 59B can be hidden from view, improving the appearance.

### Third Embodiment of Lock Device for Opening-Closing Body

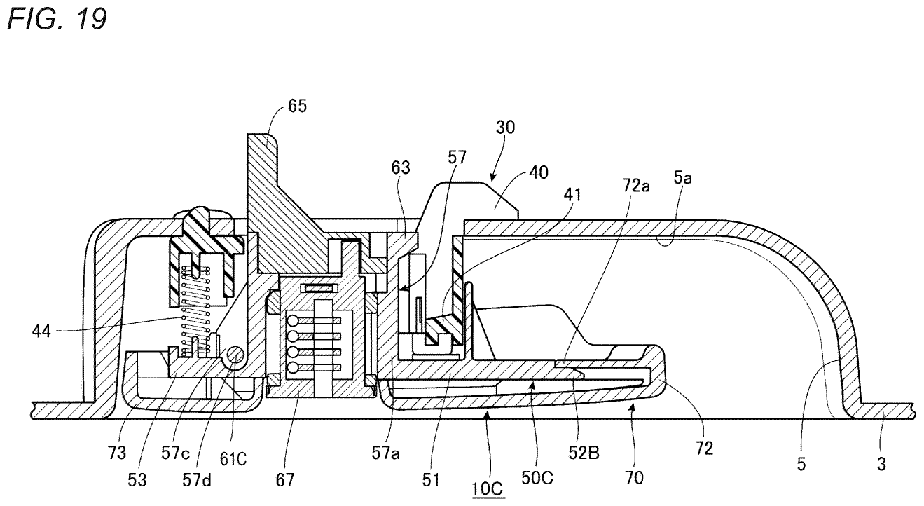

FIGS. 19 to 21 illustrate a third embodiment of the lock device for the opening-closing body according to the present invention. Parts that are substantially the same as those in the previous embodiment are given the same reference signs, and their descriptions are omitted.

In a lock device 10C of an opening-closing body (hereinafter simply referred to as a “lock device 10C”) of this embodiment, a shaft portion 61C is separate from the base member 30. Furthermore, an operating member 50C has a cover member 70 arranged on the front side of the operating plate portion 51, as in the second embodiment. Furthermore, a pair of plate-shaped pieces 57c, 57c protrude from both circumferentially opposing sides of the transmission wall portion 57 of the operating member 50C. The pair of plate-shaped pieces 57c, 57c also form the transmission wall portion 57. Furthermore, the pair of plate-shaped pieces 57c, 57c are formed with shaft insertion holes 57d, 57d having a circular hole shape.

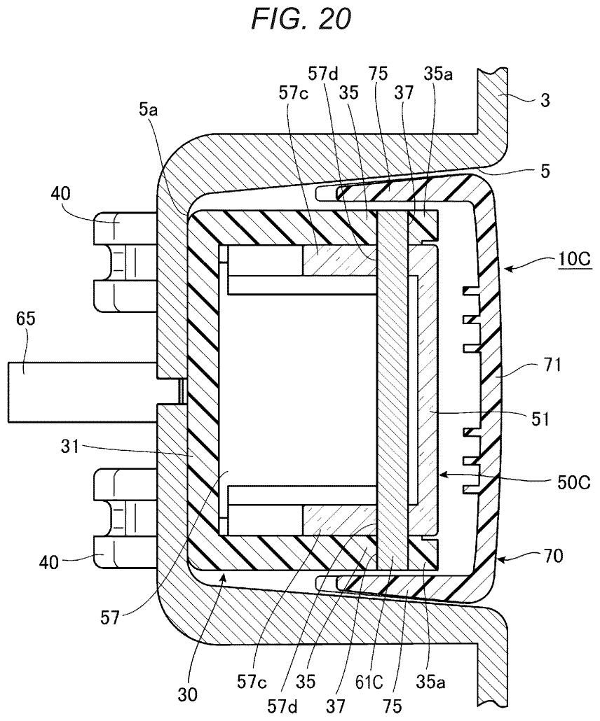

Then, as illustrated in FIG. 20, the pair of plate-shaped pieces 57c, 57c of the operating member 50C are placed inside the pair of protruding pieces 35a, 35a of the base member 30, and the shaft portion 61C is inserted into a shaft support portion 37 placed on each protruding piece 35a and the shaft insertion hole 57d formed in each plate-shaped pieces 57c. Thus, the operating member 50C is rotatably supported with respect to the base member 30 via the shaft portion 61C, the shaft support portion 37, and the shaft insertion hole 57d.

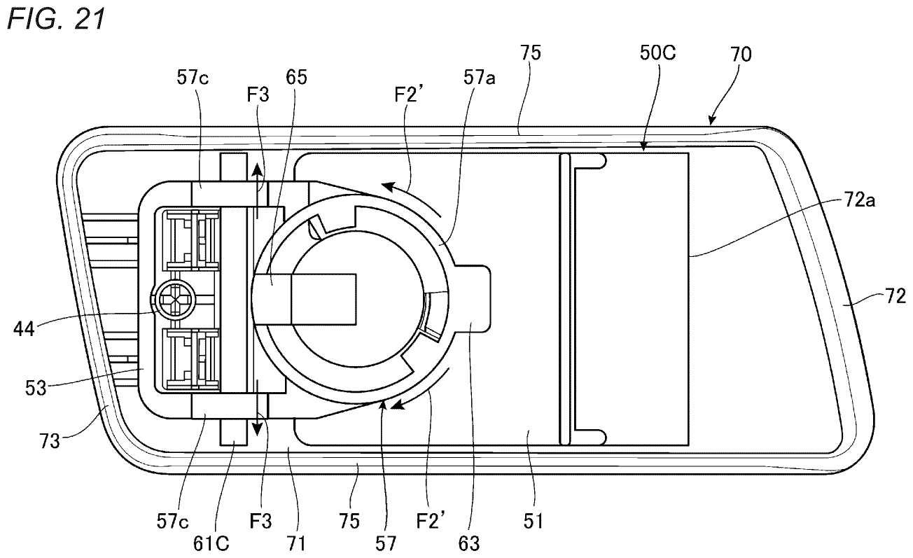

In this embodiment, when the operating portion 72 is rotated to the maximum extent with respect to the base member 30, the operating load F1′ is input from the stopper receiving portion 41 to the stopper portion 63, and the operating load F1′ is transmitted from the stopper portion 63 to the transmission wall portion 57. Then, the operating load F1′ is transmitted through the semicircular portion 57a of the transmission wall portion 57 (see the arrow F2′ in FIG. 21) and applied to the pair of plate-shaped pieces 57c, 57c, and as illustrated by the arrow F3 in FIG. 21, the pair of plate-shaped pieces 57c, 57c attempt to bend and deform in a direction away from each other. In this case, since the pair of restriction wall portions 35, 35 are arranged to face the pair of plate-shaped pieces 57c, 57c on the outside of the pair of plate-shaped pieces 57c, 57c, the deflection deformation of the pair of plate-shaped pieces 57c, 57c in the radial outward direction of the transmission wall portion 57 can be restricted, and the breaking strength of the operating member 50C can be increased.

### Fourth Embodiment of Lock Device for Opening-Closing Body

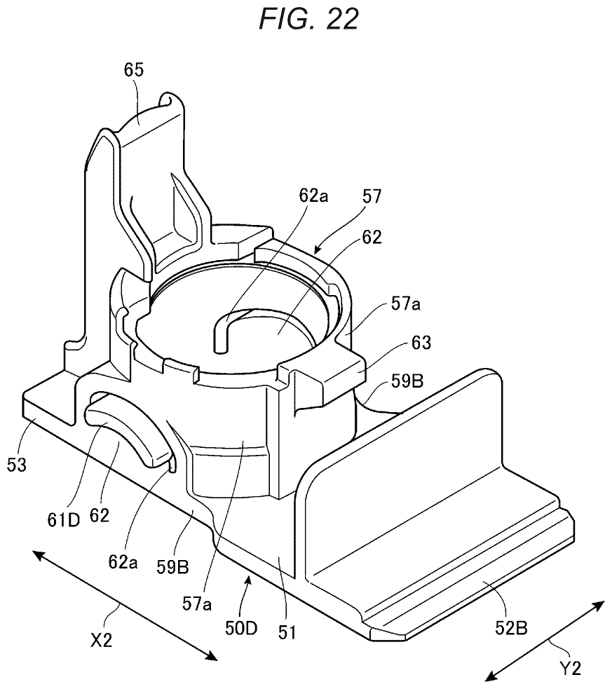

FIGS. 22 to 25 illustrate a fourth embodiment of the lock device for the opening-closing body according to the present invention. Parts that are substantially the same as those in the previous embodiment are given the same reference signs, and their descriptions are omitted.

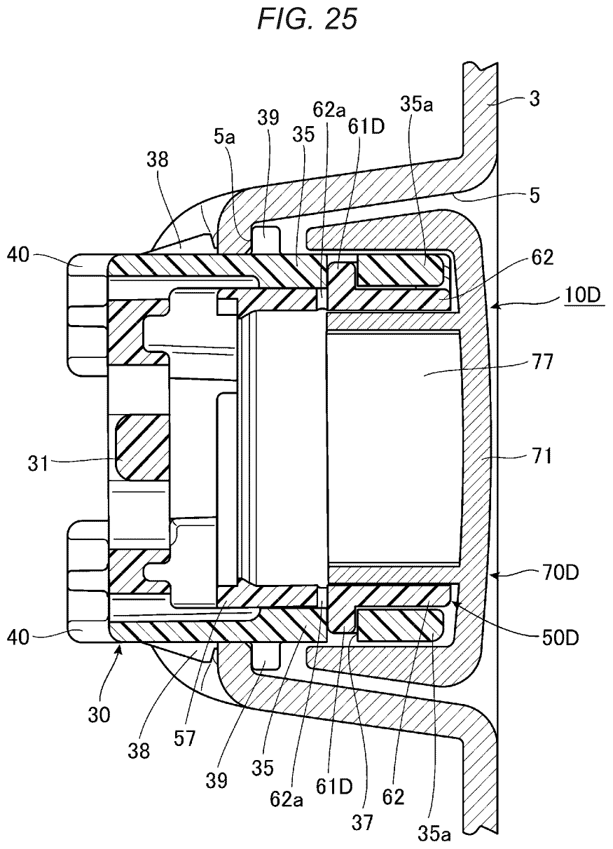

A lock device 10D for the opening-closing body (hereinafter simply referred to as a “lock device 10D”) of the fourth embodiment illustrated in FIG. 25 has a structure similar to that of the second embodiment, but differs in that a slit 62a is formed adjacent to a shaft portion 61D.

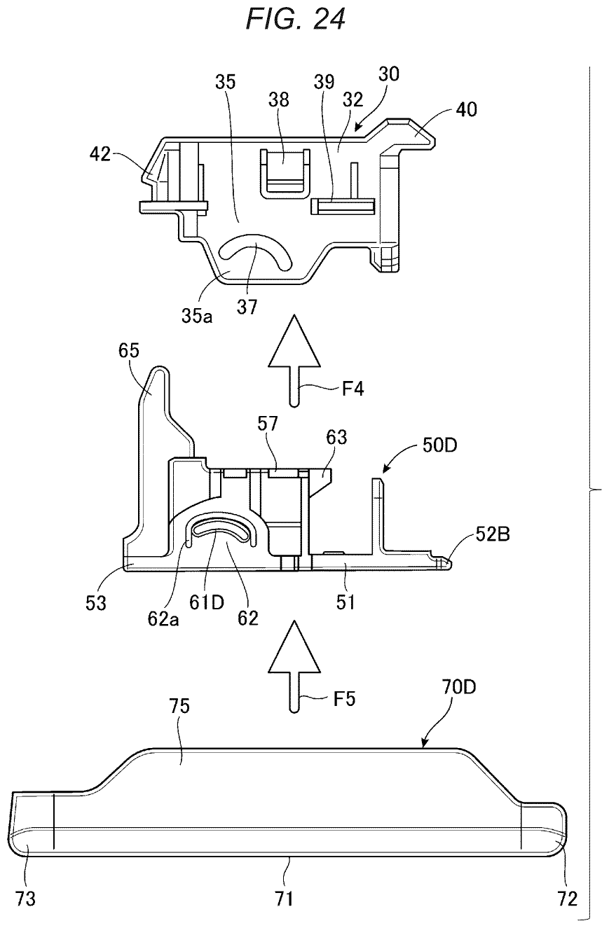

Specifically, as illustrated in FIG. 22, a pair of shaft portions 61D are arc-shaped protrusions integrally formed with the transmission wall portion 57, and the slit 62a is formed at a position adjacent to each shaft portion 61D. Also, as illustrated in FIG. 24, a pair of deformation restriction wall portions 35, 35 of the base member 30 are integrally formed with shaft support portions 37, 37 The slit 62a is formed by an arc-shaped portion extending along a peripheral edge of a tip end side of the shaft portion 61D in the erection direction of the transmission wall portion 57, and portions extending parallel to each other from the arc-shaped portion toward the base end side in the erection direction of the transmission wall portion 57. Through this slit 62a, an adjacent portion 62 (hereinafter also simply referred to as a “shaft portion adjacent portion 62”) of the shaft portion 61D can be bent and deformed inward and outward of the operating member 50D.

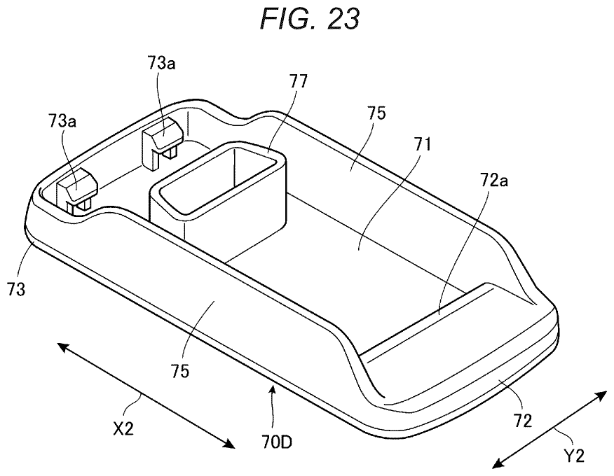

In addition, an inward deflection restricting portion 77 that restricts the deflection deformation (here, the deflection deformation of the pair of shaft portion adjacent portions 62, 62 toward the inside of the transmission wall portion 57) of the pair of shaft portion adjacent portions 62, 62 toward the inside of the operating member 50D is arranged inside the pair of shaft portion adjacent portions 62, 62. Here, as illustrated in FIG. 23, the inward deflection restricting portion 77 having a substantially trapezoidal frame shape that is inserted into the transmission wall portion 57 is erected from the back side of the cover member 70D, and this inward deflection restricting portion 77 is arranged inside the pair of shaft portion adjacent portions 62, 62, so that the deflection deformation of the pair of shaft portion adjacent portions 62, 62 toward the inside of the transmission wall portion 57 is restricted. In addition, the inward deflection restricting portion 77 as described above may be replaced by a key cylinder 67 to restrict the deflection deformation of the pair of shaft portion adjacent portions 62, 62 toward the inside of the transmission wall portion 57.

In addition, a pair of wall portions 75, 75 of the cover member 70D are positioned outside the pair of shaft portion adjacent portions 62, 62, so as to restrict deflection deformation of the pair of shaft portion adjacent portions 62, 62 toward the outside of the transmission wall portion 57 (see FIG. 25).

In addition to the above-described embodiment, the structure having the slit may be any of the following embodiments (1) to (5).

In other words, assuming that the shaft portion is protrusion-shaped and the shaft support portion is groove-shaped (similar to the above structure), the structure may be such that (1) a slit is formed at each of a position adjacent to the shaft portion and a position adjacent to the shaft support portion, so that both the slit adjacent portion of the shaft portion and the slit adjacent portion of the shaft support portion are capable of deflection deformation, or (2) no slit is formed at a position adjacent to the shaft portion, while a slit is formed at a position adjacent to the shaft support portion, so that only the slit adjacent portion of the shaft support portion is capable of deflection deformation

In addition, assuming that the shaft portion is groove-shaped and the shaft support portion is protrusion-shaped, the structure may be such that (3) a slit is formed at a position adjacent to the shaft portion, while no slit is formed at a position adjacent to the shaft support portion, and only the slit adjacent portion of the shaft portion is capable of deflection deformation, (4) a slit is formed at each of a position adjacent to the shaft portion and a position adjacent to the shaft support portion, and both the slit adjacent portion of the shaft portion and the slit adjacent portion of the shaft support portion are capable of deflection deformation, or (5) no slit is formed at a position adjacent to the shaft portion, while a slit is formed at a position adjacent to the shaft support portion, and only the slit adjacent portion of the shaft support portion is capable of deflection deformation.

In addition, in this embodiment, the shaft portion 61D is integrally formed with the operating load transmission wall portion 57, and the shaft support portions 37 are integrally formed with the pair of deformation restriction wall portions 35, 35, but the shaft support portion may be integrally formed with the operating load transmission wall portion, and the shaft portions may be integrally formed with the pair of deformation restriction wall portions.

In addition, when the slit adjacent portion of the shaft portion or the slit adjacent portion of the shaft support portion can be bent and deformed inward or outward of the operating member or the base member by the above structures (1) to (5), an inward deflection restricting portion or a key cylinder is disposed inside the slit adjacent portion of the shaft portion or the slit adjacent portion of the shaft support portion, and an outward deflection restricting portion is disposed outside the slit adjacent portion of the shaft portion or the slit adjacent portion of the shaft support portion. That is, (a) a structure (this structure is used in the fourth embodiment illustrated in FIGS. 22 to 25) having only an inward deflection restricting portion or a key cylinder, (b) a structure having only an outward deflection restricting portion, and (c) a structure having both an inward deflection restricting portion or a key cylinder and an outward deflection restricting portion are provided.

In this embodiment, as illustrated by the arrow F4 in FIG. 24, the operating member 50D is first assembled to the base member 30. In this case, the pair of transmission wall portions 57, 57 are inserted inside the pair of restriction wall portions 35, 35, and in this case, the tip ends of the pair of shaft portions 61D, 61D are pressed by the inner surfaces of the pair of restriction wall portions 35, 35, and the pair of shaft portion adjacent portions 62, 62 are inserted while being bent and deformed inward. When the pair of shaft portions 61D, 61D reach the pair of shaft support portions 37, 37, the pair of shaft portion adjacent portions 62, 62 elastically return, and the pair of shaft portions 61D, 61D are inserted into the pair of shaft support portions 37, 37, and the operating member 50D is assembled to the base member 30.

Thereafter, as illustrated by the arrow F5 in FIG. 24, the cover member 70D is attached to the operating member 50D. That is, the tip end 52B of the operating plate portion 51 is inserted into and engaged with the lock frame portion 72a of the cover plate portion 71, and the lock protrusions 73a, 73a of the cover plate portion 71 are engaged with both sides in the width direction of the base end 53 of the operating plate portion 51, thereby attaching the cover member 70D to the front side of the operating plate portion 51. In this case, as illustrated in FIG. 25, the inward deflection restricting portion 77 provided on the cover member 70D is inserted and positioned inside the pair of shaft portion adjacent portions 62, 62, and the deflection deformation of the pair of shaft portion adjacent portions 62, 62 inward of the operating member 50D, that is, inward of the transmission wall portion 57, is restricted.

As described above, in this embodiment, the operating load transmission wall portion and/or the pair of deformation restriction wall portions have slits formed at positions adjacent to the shaft portion and/or the shaft support portion, and the adjacent portion of the shaft portion and/or the adjacent portion of the shaft support portion can be bent and deformed inward and outward of the operating member or base member through the slits (here, the slit 62a is formed at a position adjacent to the shaft portion 61D, and the shaft portion adjacent portion 62 can be bent and deformed inward and outward of the transmission wall portion 57 of the operating member 50D through the slit 62a), thereby improving the workability of assembling of the operating member 50 to the base member 30.

In addition, there is an inward deflection restricting portion or key cylinder that is arranged inside the adjacent portion of the shaft portion or the shaft support portion and that restricts the inward deflection deformation of the operating load transmission wall portion, and/or an outward deflection restricting portion that is arranged outside the adjacent portion of the shaft support portion or the shaft portion and that restricts the outward deflection deformation of the pair of deformation restriction wall portions. Here, the inward deflection restricting portion 77 is arranged inside the pair of shaft portion adjacent portions 62, 62. As a result, after the operating member 50D is assembled to the base member 30, it is possible to make it difficult for the operating member 50D to come off from the base member 30. In other words, the deflection deformation of the slit adjacent portion of the shaft portion and the slit adjacent portion of the shaft support portion formed through the slits can be restricted by the inward deflection restricting portion or the key cylinder, or the outward deflection restricting portion, thereby making it difficult for the operating member to come off from the base member.

The present invention is not limited to the above-described embodiments, and various modified embodiments are possible within the scope of the gist of the present invention, and such embodiments are also included in the scope of the present invention.

### REFERENCE SIGNS LIST

1 fixed body
1a opening portion
1b, 1b lock portion
2 opening-closing body
10, 10B, 10C, 10D lock device for opening-closing body (lock device)
20 lock member
25 rotation member
27 torsion spring
30 base member
35 deformation restriction wall portion
37 shaft support portion
41 stopper receiving portion
50, 50A, 50B, 50C, 50D operating member
51 operating plate portion
52 operating portion
57, 68 operating load transmission wall portion (transmission wall portion)
59B, 59B notch
61, 61C, 61D shaft portion
63 stopper portion
67 key cylinder
70,70D cover member
72 operating portion
77 inward deflection restricting portion

1. A lock device for an opening-closing body that is configured to be openably and closably attached to an opening portion of a fixed body, comprising:
a lock portion provided on one of the fixed body and the opening-closing body;
a lock member that is disposed on another of the fixed body and the opening-closing body and that is configured to engage with and disengage from the lock portion;
a base member that is fixed to the other of the fixed body and the opening-closing body; and
an operating member that is rotatably supported on the base member via a rotation portion and that is configured to operate the lock member, wherein
the rotation portion is formed by shaft portions provided on one of the operating member and the base member, and shaft support portions provided on another of the operating member and the base member to rotatably support the shaft portions,
the operating member has an operating plate portion extending in a plate shape, an operating portion provided at one end of the operating plate portion in an extension direction, an operating load transmission wall portion protruding from a back side of the operating plate portion, the shaft portions disposed so as to protrude from both sides of the operating load transmission wall portion toward the outside of the operating member or the shaft support portions disposed on the operating load transmission wall portion, and a stopper portion connected to the operating load transmission wall portion on a side of the operating portion with respect to the shaft portions or the shaft support portions, and
the base member has a pair of deformation restriction wall portions disposed outside portions of the operating load transmission wall portion where the shaft portions or the shaft support portions are provided, the shaft support portions disposed on the pair of deformation restriction wall portions or the shaft portions disposed to protrude from the pair of deformation restriction wall portions toward the operating load transmission wall portion, and a stopper receiving portion that is capable of coming into contact with the stopper portion and that is configured to restrict rotation of the operating member.

2. The lock device for the opening-closing body according to claim 1, wherein
the operating load transmission wall portion is cylindrical shape in which a key cylinder can be inserted.

3. The lock device for the opening-closing body according to claim 1, wherein
a pair of notches into which the pair of deformation restriction wall portions are inserted, are formed on both sides of the operating plate portion along the extension direction, and
the operating member further has a cover member arranged on a front side of the operating plate portion, and the cover member is provided with a wall portion that cover the pair of notches.

4. The lock device for the opening-closing body according to claim 1, wherein
the shaft portions or the shaft support portions are integrally formed with the operating load transmission wall portion,
the shaft support portions or the shaft portions are integrally formed with the pair of deformation restriction wall portions,
a slit is formed in the operating load transmission wall portion and/or the pair of deformation restriction wall portions at each of positions adjacent to the shaft portions and/or the shaft support portions, and each of adjacent portions of the shaft portions and/or each of adjacent portions of the shaft support portions can be bent and deformed inward and outward of the operating member or the base member via the slit, and
an inward deflection restricting portion or a key cylinder that is arranged inside adjacent portions of the shaft portions or the shaft support portions and that is configured to restrict inward deflection deformation of the operating load transmission wall portion and/or an outward deflection restricting portion that is arranged outside the adjacent portions of the shaft support portions or the shaft portions and that is configured to restrict outward deflection deformation of the pair of deformation restriction wall portions are provided.
